(19) United States
(12) Patent Application Publication
(10) Pub. No.: US 2011/0290650 A1
(43) Pub. Date: Dec. 1, 2011

(54) APPARATUS FOR PRODUCING ALKALINE WATER

(76) Inventor: Kook Bum BANG, Philadelphia, PA (US)

(21) Appl. No.: 12/788,972

(22) Filed: May 27, 2010

(51) Int. Cl. C02F 1/48; C02F 1/66

(52) U.S. Cl. 204/665; 204/660

(57) ABSTRACT

A vessel for producing alkaline water, includes a pipe, a rod disposed within the pipe; at least one support to support the rod to the pipe; and at least one magnetic material disposed on the pipe.

### BACKGROUND OF THE INVENTION

1. Field of the Invention

Embodiments of the invention are directed generally to an apparatus for producing alkaline water. More particularly, embodiments of the invention are directed to an apparatus for producing alkaline water and a vessel that converts regular water into alkaline water.

2. Discussion of the Related Art Alkaline water, for the purposes of the explanation, is water having a pH above a balanced pH, although water with a pH above 7.0 is by general definition alkaline. Alkaline water may be produced by various methods, such as by electrolysis of potable source water. Alkaline water can be produced, alternatively, by adding alkaline minerals to potable source water, such as tap water.

Alkaline water is known to have certain health benefits, including antioxidant properties, and studies exists that support or confirm such findings of antioxidant properties and other health benefits of alkaline water.

### SUMMARY OF THE INVENTION

An object of the invention is to provide an apparatus to produce or enhance the production of alkaline water from a water source, such as tap water.

Additional features and advantages of the invention will be set forth in the description which follows, and in part will be apparent from the description, or may be learned by practice of the invention. The objectives and other advantages of the invention will be realized and attained by the structure particularly pointed out in the written description and claims thereof as well as the appended drawings.

To achieve these and other advantages and in accordance with the purpose of the invention, as embodied and broadly described, a vessel for producing alkaline water, includes a pipe, a rod disposed within the pipe; at least one support to support the rod to the pipe; and at least one magnetic material disposed on the pipe.

According to another embodiment of the invention, an apparatus for producing alkaline water, includes a vessel to convert water into alkaline water, the vessel including, a pipe, a rod disposed within the pipe, at least one support to support the rod to the pipe, and at least one magnetic material disposed on the pipe; at least one filter to filter the water; and a piping to carry the water from the at least one filter to the vessel.

According to another embodiment of the invention, a vessel to produce alkaline water, includes an outer wall that forms a container to hold water, the outer wall being opened on top, and including a cylindrical side wall and a circular bottom wall; and a plurality of magnets arranged on the side wall and at least one magnet arranged on the bottom wall.

### BRIEF DESCRIPTION OF THE DRAWINGS

The accompanying drawings, which are included to provide a further understanding of the invention, and are incorporated in and constitute a part of the specification, illustrate embodiments of the invention and together with the description serve to explain the principles of the invention. In the drawings:

FIG. 1 shows a vessel for producing alkaline water according an example embodiment of the invention;

FIG. 2 shows a cylinder of a vessel for producing alkaline water according to an example embodiment of the invention;

FIG. 3 shows a rod of a vessel for producing alkaline water according to an example embodiment of the invention;

FIGS. 4A-4C show cross sections of various pipes and rods of a vessel for producing alkaline water according to example embodiments of the invention;

FIG. 5 shows a cut-away view of a vessel for producing alkaline water according another example embodiment of the invention;

FIG. 6 shows a vessel for producing alkaline drinking water according an example embodiment of the invention; and

FIG. 7 shows an apparatus that includes a vessel for producing alkaline water according to an embodiment of the invention.

### DETAILED DESCRIPTION OF THE EMBODIMENTS

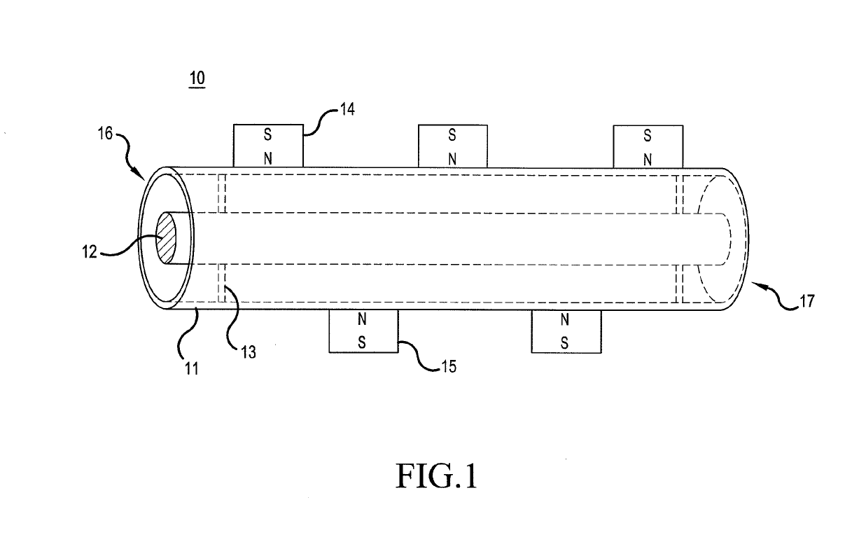

Hereinafter, example embodiments of the invention will be described in detail with reference to FIGS. 1-7. Like reference numerals designate like elements throughout the specification.

FIG. 1 shows a vessel for producing alkaline water according to an example embodiment of the invention. As shown in FIG. 1, the vessel 10 for producing alkaline water includes a pipe (a tube or a piped) 11, a rod 12, one or more supports 13 that supports the rod 12 to the pipe 11, and one or more magnetic materials 14, 15 disposed on the pipe 11.

The pipe 11 is one having a hollow interior, and having an exterior wall that defines and encloses the hollow interior. In an embodiment of the invention, the pipe 11 generally has a cylindrical shape and a circular cross section. Accordingly, the pipe 11 may have a predetermined diameter. Nevertheless, in other embodiments, the pipe 11 may be a parrellopiped, and may have a non-circular cross section. Since the interior of the pipe 11 is hollow, the pipe 11 accommodates a rod 12 therein.

The rod 12 is one that generally has a shape that matches the pipe 11, and in one embodiment, has a cylindrical shape and a circular cross section. In such an instance, the rod 12 has a diameter that is smaller than a diameter of the pipe 11, so that the rod 12 is accommodated in the interior of the pipe 11 with a certain space between the rod 12 and the pipe 11. The rod 12 is generally positioned along an axis of the pipe 11.

The rod 12 may have a solid interior or may be a kind of pipe with a hollow interior. The rod 12 takes up space in the interior of the pipe 11. For example, the rod 12 may take up space in the middle axial portion of the pipe 11 so that any fluid will be displaced from the middle axial portion of the pipe 11. In such an instance, the fluid will be forced to flow more immediately along an inner surface of the exterior wall of the pipe 11, rather than along the middle axial portion of the pipe 11. Nevertheless, in other embodiments, the rod 12 may be removed so that fluid is able to flow entirely within the interior of the pipe 11.

The rod 12 is supported by one or more supports 13. The one or more supports 13 generally extend between the rod 12 and the pipe 11. The one or more supports 13 may be wires, rods, meshes, or flanges that are attached at one end to the pipe 11 and attached at an opposite end to the rod 12. The one or more supports 13 may be attached to the pipe 11 and the rod 12 by bonding using an adhesive, by welding, or by fastening using a fastener. Other attachment methods are possible. The one or more supports 13 may be arranged in a periodic manner or may be arranged in a random manner. In an embodiment of the invention, the one or more supports 13 may be long vanes that are almost as long as the length of the rod 12 and/or the pipe 11. The long vanes may extend in the axial direction of the rod 12.

The material for the pipe 11, the rod 12, or the support 13 is not limited, and may be resin, polymer, metal, glass or a combination thereof. Other materials may also be used. Additionally, one or both of the pipe 11 and the rod 12 may be opaque or transparent, or one or both of the pipe 11 and the rod 12 may each have portions that are opaque and portions that are transparent.

Between the rod 12 and the pipe 11 exists space for fluids. The fluids may be stationary or may be flowing. When flowing, the fluids may enter the pipe 11 at entrance 17 and exit the pipe 11 at exit 16. The fluid may be water.

One or more magnetic materials 14, 15 are disposed on the pipe 11. The one or more magnetic materials are placed over an exterior surface of the pipe 11 so that one of the magnetic poles thereof is positioned towards the exterior surface of the pipe 11, while another of the magnetic poles thereof is positioned away from the exterior surface of the pipe 11. In an embodiment of the invention, the magnetic pole that is positioned towards the exterior surface of the pipe 11 is the “N” pole, and the magnetic pole that is positioned away from the exterior surface of the pipe 11 is the “S” pole. In other words, the “N” pole portion of the magnetic materials 14, 15 is positioned towards the exterior surface of the pipe 11.

In an embodiment of the invention, the one or more magnetic materials 14, 15 may be shaped as blocks or bars. For example, the blocks or bars may be rectangular, but other shapes are possible, such as circular, cubical or triangular. The one or more magnetic materials 14, 15 may be formed with a curvature so that the one or more magnetic materials 14, 15 follow the curvature of the pipe 11. One or more magnetic materials 14, 15 may be formed to cover about 45 degrees of arc over the exterior surface of the pipe 11. Other degrees of arc are also possible. The curvature of the one or more magnetic materials 14, 15 may fit the curvature of the exterior surface of the pipe 11, and may be formed on only one surface that faces the exterior surface of the pipe 11 in the one or more magnetic materials 14, 15, or the curvature may be formed in a main body of the one or more magnetic materials 14, 15 so that the main body itself may be curved.

When a plurality of magnetic materials 14, 15 are used, the plurality of magnetic materials 14, 15 are offset from each other, and arranged on the exterior surface of the pipe 11 so that the “same” poles do not interfere or interfere less with each other. For example, the plurality of magnetic materials 14, 15 may be arranged separated both in the axial direction of pipe 11, and in the curvature direction (or angular direction) of the pipe 11. The distance (a first distance) between the plurality of magnetic materials 14, in the axial direction of the pipe 11 may be the same or different. Additionally, the distance (a second distance) between the plurality of magnetic materials 14, 15 in the curvature direction of the pipe 11 may be the same or different. In an embodiment of the invention, the first and second distances may be the same or different. In an embodiment of the invention, the plurality of magnetic materials 14, 15 may alternate in both the axial and curvature directions in a checkerboard pattern. In an embodiment of the invention, the plurality of magnetic materials 14, 15 may be arranged in a ring, and a plurality of rings may separated along the axial direction of the pipe 11.

In an embodiment of the invention, one or more magnetic materials 14, 15 are magnets, such as permanent magnets, and include ferromagnetic or ferrimagnetic materials. These magnets include iron, nickel, cobalt, some rare earth metals and some of their alloys, as well as other materials.

For example, the magnets may be ceramic or ferrite magnets, and may be made of a sintered composite of powdered iron oxide and barium/strontium carbonate ceramic; Alnico magnets made by casting or sintering a combination of aluminum, nickel and cobalt with iron and small amounts of other elements added to enhance the properties of the magnet; Ticonal magnets made by an alloy of titanium, cobalt, nickel, and aluminum, with iron and small amounts of other elements; injection molded magnets of composite of various types of resin and magnetic powders, allowing parts of complex shapes to be manufactured by injection molding; flexible magnets that are similar to injection molded magnets, and uses a flexible resin or binder such as vinyl, and are produced in flat strips, shapes or sheets; or other permanent magnets. Additionally, the magnets may be electromagnets, which may be turned on and off as needed or desired. In an embodiment of the invention, the magnets may be attached to the exterior surface of the pipe 11 by bonding using an adhesive, by welding, or by fastening using a fastener. Other attachment methods are possible.

Accordingly, by having the “N” pole portion of the magnetic materials 14, 15 positioned towards the exterior surface of the pipe 11, alkaline water is produced, production of the alkaline water is enhanced, the water is made more alkaline, and/or the water is made less acidic. That is, a pH of water is raised. In an embodiment of the invention, the pH of water that enters the pipe 11 at the entrance 17 is different from the pH of the water that exits the pipe at the exit 16. In an embodiment of the invention, the pH of water that enters the pipe 11 at the entrance 17 is lower than the pH of the water that exits the pipe 11 at the exit 16. For example, the pH of the water that exits the pipe 11 may be higher than 7.0. In an embodiment of the invention, the pH of the water that exits the pipe 11 may be about 7.1 to about 10. Higher pH values are possible.

Additionally, the water that exits the pipe 11 may be structured water, and may have hexagonal clustering or shapes over a predetermined period of time and/or over a predetermined distance range.

On the other hand, if the “S” pole portion of the magnetic materials 14, 15 is positioned towards the exterior surface of the pipe 11, acidic water may be produced, or water may be made more acidic. That is, the pH of water is lowered.

Further, if the “S” pole portion of one of the magnetic materials 14, 15, and the “N” pole portion of another of the magnetic materials 14, 15 are placed on the pipe 11 in an alternating manner, neutral water may be produced, or the pH of water is not changed. That is, the pH of water is maintained, or the pH of water is made neutral (i.e. about 7.0).

In an embodiment of the invention, a covering may further cover the pipe 11 and the one or more magnetic materials 14, 15, and the covering may include resin, plastic, glass, rubber, or a combination thereof.

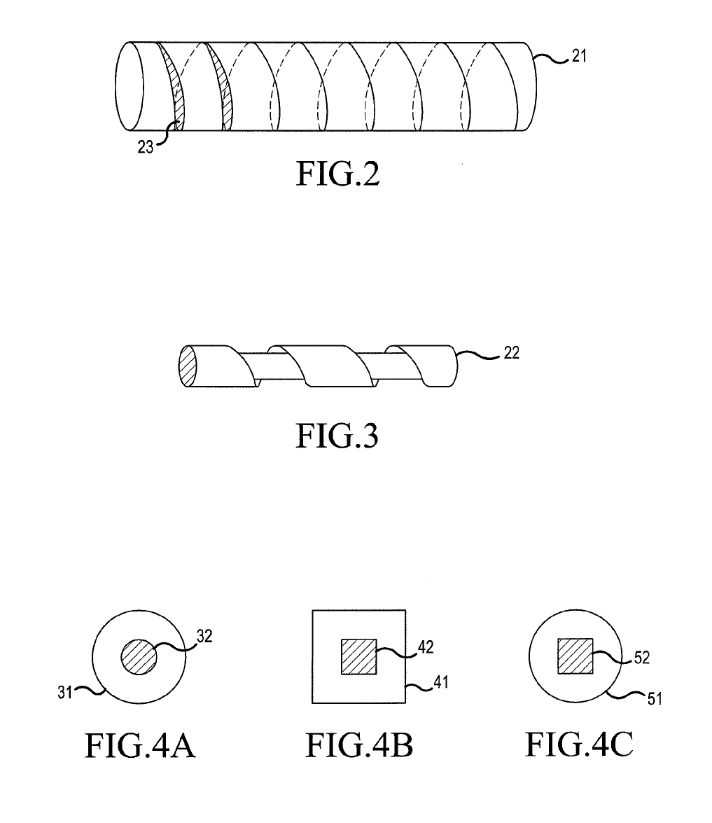

FIG. 2 shows a cylinder of a vessel for producing alkaline water according to an example embodiment of the invention. As shown in FIG. 2, the vessel shown is similar to the pipe 11 of FIG. 1, and has an exterior wall 21 that has a generally has a cylindrical shape and a circular cross section. Positioned on an inner surface of the exterior wall 21 is a vane 23 that extends from one end to an opposite end of the exterior wall 21. The vane 23 is spiral in shape. In the embodiment shown in FIG. 2, the vane 23 does not contact the rod (not shown), so that the vane 23 is an additional structure to the supports 13 that are shown in FIG. 1. The vane 23 stirs the water so that water, or the molecules of water, are more easily mixed as they flow from one end to an opposite end of the vessel. Accordingly, in view of FIG. 1 having the magnets 14, 15 arranged on the pipe 11, the molecules of water are made to more likely contact the inner surface of the exterior wall 21, or made to come closer to the magnets 14, 15 arranged on the pipe 11 by the mixing of water and/or the molecules of water.

Although the vane 23 is shown as a spiral or in a spiral arrangement along the inner surface of the exterior wall 21 in a continuous manner, embodiments of the invention are not limited thereto, and the vane 23 may be in the form of rings, protrusions, or other discontinuous elements.

FIG. 3 shows a rod of a vessel for producing alkaline water according to an example embodiment of the invention. As shown in FIG. 3, the rod shown has a groove 22 that extends from one end to an opposite end of the rod. The groove 22 is spiral in shape. In the embodiment shown in FIG. 3, the groove 22 is formed in the rod. The groove 23 stirs the water so that water, or the molecules of water, are more easily mixed as they flow from one end to an opposite end of the vessel. Accordingly, in view of FIG. 1 having the magnets 14, 15 arranged on the pipe 11, when the rod having the groove 22 is used in conjunction with the pipe 11, the molecules of water are made to more likely contact the inner surface of the pipe 11, or made to come closer to the magnets 14, 15 arranged on the pipe 11 by the mixing of water and/or the molecules of water.

Although the groove 22 is shown as a spiral or in a spiral arrangement along the outer periphery of the rod in a continuous manner, embodiments of the invention are not limited thereto, and the groove 22 may be in the form of recessed rings, protruding rings, protruding vanes, protrusions, or other discontinuous elements.

In a modified embodiment, the rod shown in FIG. 3 may have a diameter that is about equal to or just slightly less than the inner diameter of the pipe 11 as shown in view of FIG. 1, for example, so that the water is forced to flow essentially along the groove 22. In such an instance, the magnets 14, 15 may be arranged on the pipe 11 at locations corresponding to the groove 22.

FIGS. 4A-4C show cross sections of various pipes and rods of a vessel for producing alkaline water according to example embodiments of the invention. As shown in FIG. 4A, a pipe 31 has a circular cross section, and is paired with a rod 32 also having a circular cross section. In FIG. 4B, a pipe 41 has a square cross section, and is paired with a rod 42 also having a square cross section. In FIG. 4C, a pipe 51 has a circular cross section, and is paired with a rod 52 having a square cross section. Thus, a cross section of a pipe may be the same or different from a cross section of a rod that is paired thereto. Additionally, the cross section of the pipe and the cross section of the rod may be other shapes, including oval, triangular, rectangular, hexagonal, other polygons, or other regular or irregular shapes.

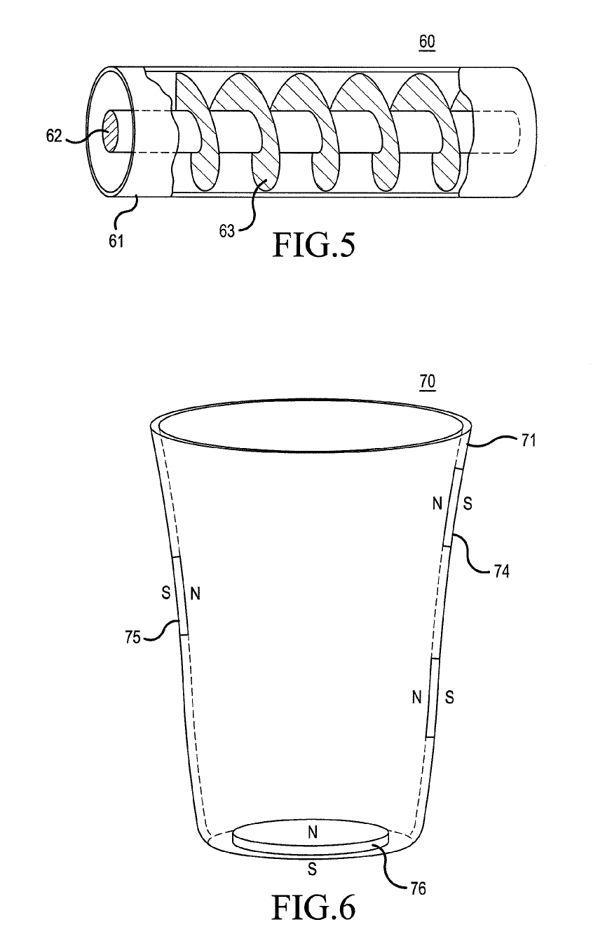

FIG. 5 shows a cut-away view of a vessel for producing alkaline water according another example embodiment of the invention. As shown in FIG. 5, the vessel 60 includes a pipe 61, a rod 62 and a support 63. The magnets 14, 15 are not shown, but may be arranged in a similar manner as described above for FIG. 1.

The rod 62 is supported by the support 63. The support 63 extends between the rod 62 and the pipe 61, and is formed in a spiral about the axial direction of the rod 62. Accordingly, water flows in a cork-screw manner within the interior of the pipe 61.

FIG. 6 shows a vessel for producing alkaline drinking water according an example embodiment of the invention. As shown in FIG. 6, the vessel 70 includes an outer wall 71 that forms a container to hold water, and which is opened on top, and one or more magnets 74, 75 and 76. Some of the magnets 74, 75 are arranged on a side wall of the vessel 70, while at least one magnet 76 is arranged on a bottom wall of the vessel 70. The magnets 74, 75 and 76 are arranged so that the “N” poles thereof face toward the exterior surface of the outer wall 71. In an embodiment of the invention, the magnets 74, 75 and 76 are formed or attached to be flush with a surface of the outer wall 71. The vessel 70 may be a cup or a mug, for example. The vessel may be a jug or a large container of water. In an embodiment of the invention, when water is contained in the vessel 70, such as regular tap water or filtered water, such water is converted into alkaline drinking water.

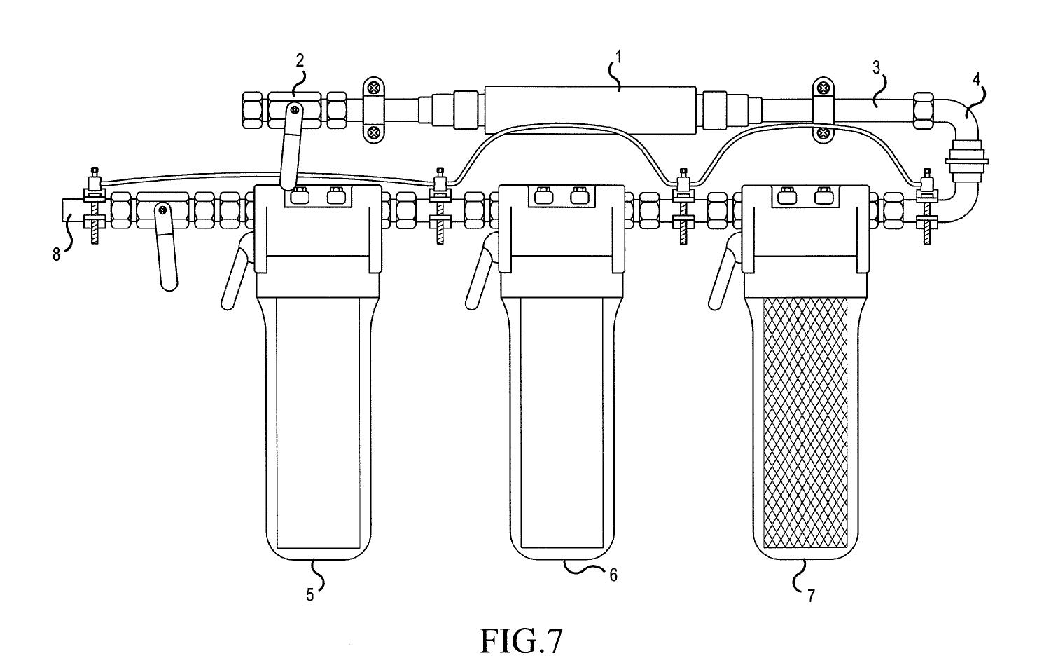

FIG. 7 shows an apparatus that includes a vessel for producing alkaline water according to an embodiment of the invention. As shown in FIG. 7, the apparatus includes a vessel 1 for producing alkaline water, an output valve 2 to output alkaline water, piping 3 to carry water to the vessel 1, an optional pipe bend 4, one or more filters 5-7, and an input 8.

The vessel 1 may be the same or similar to the various embodiments of vessels discussed with respect to FIGS. 1-5. The output valve 2 enables one to selectively output alkaline water (structured water or hexagonal water) produced from the vessel 1. The piping 3 carries filtered water from the filters 5-7 to the vessel 1 via the pipe bend 4. The filters 5-7 filter the water, and remove or reduce, for example, chlorine, minerals, sediments, microbes, or other foreign material. Accordingly, water, such as regular tap water, enters through the input 8, is filtered by the filters 5-7, is carried by the pipe bend 4 and the piping 3 to the vessel 1, whereupon alkaline water is produced. That is, as water flows through the vessel 1, the water is converted into alkaline water. Thereafter, the alkaline water is selectively output via the output valve 2.

Although example embodiments have been described with reference to a number of illustrative examples, it should be understood that numerous other modifications and changes can be devised by those skilled in the art that will fall within the scope of the principles of the disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A vessel for producing alkaline water, the vessel comprising:
a pipe,
a rod disposed within the pipe;
at least one support to support the rod to the pipe; and
at least one magnetic material disposed on the pipe.

2. The vessel of claim 1, wherein the pipe has a cylindrical shape and a circular cross section.

3. The vessel of claim 1, wherein the rod is positioned along an axis of the pipe, and the rod has a cylindrical shape and a circular cross section.

4. The vessel of claim 1, wherein the rod has a diameter that is smaller than a diameter of the pipe so that the rod is accommodated in the interior of the pipe with a certain space between the rod and the pipe.

5. The vessel of claim 1, wherein the rod has a solid interior.

6. The vessel of claim 1, wherein the at least one support extends between the rod and the pipe, and is attached at one end to the pipe and attached at an opposite end to the rod.

7. The vessel of claim 1, wherein the at least one magnetic material is a permanent magnet.

8. The vessel of claim 1, wherein the at least one magnetic material is placed over an exterior surface of the pipe so that one of the poles is positioned towards the exterior surface of the pipe while another of the poles is positioned away from the exterior surface of the pipe.

9. The vessel of claim 8, wherein the one pole that is positioned towards the exterior surface of the pipe is the “N” pole.

10. The vessel of claim 1, wherein a shape of the at least one magnetic material is a rectangular bar.

11. The vessel of claim 1, wherein the at least one magnetic material has a curvature that matches a curvature of the pipe.

12. The vessel of claim 1, wherein the at least one magnetic material is formed to cover about 45 degrees of an arc over an exterior surface of the pipe.

13. The vessel of claim 1, wherein the at least one magnetic material includes a plurality of magnetic materials, and the plurality of magnetic materials are placed over an exterior surface of the pipe, and offset from each other.

14. The vessel of claim 1, wherein a pH of water that is output from the vessel is different from a pH of water that is input to the vessel.

15. The vessel of claim 14, wherein the pH of the water that is output from the vessel is higher than the pH of the water that is input to the vessel.

16. The vessel of claim 1, wherein a pH of water that is output from the vessel is between about 7.1 to about 10.

17. The vessel of claim 1, wherein the at least one support is formed in a shape of a spiral.

18. The vessel of claim 1, wherein the rod includes a spiral groove.

19. An apparatus for producing alkaline water, the apparatus comprising:
a vessel to convert water into alkaline water, the vessel including,
a pipe,
a rod disposed within the pipe,
at least one support to support the rod to the pipe, and
at least one magnetic material disposed on the pipe;
at least one filter to filter the water; and
a piping to carry the water from the at least one filter to the vessel.

20. A vessel to produce alkaline drinking water, the vessel comprising:
an outer wall that forms a container to hold water, the outer wall being opened on top, and including a cylindrical side wall and a circular bottom wall; and
a plurality of magnets arranged on the side wall and at least one magnet arranged on the bottom wall.
